(19) United States
(12) Patent Application Publication
(10) Pub. No.: US 2006/0140392 A1
(43) Pub. Date: Jun. 29, 2006

(54) Echo detector having correlator with preprocessing

(76) Inventor: Masoud Ahmadi, Whetstone (GB)

Correspondence Address: BARNES & THORNBURG, LLP, P.O. BOX 2786, CHICAGO, IL, 60690-2786, US

(21) Appl. No.: 10/537,105

(22) PCT Filed: Feb. 21, 2003
(86) PCT No.: PCT/GB03/00745

§ 371 Date: Feb. 15, 2006

(30) Foreign Application Priority Data
Feb. 21, 2002 (GB) 0204057.4

(51) Int. Cl. H04M 9/08

(52) U.S. Cl. 379/406.1

(57) ABSTRACT

An echo detector correlates between an incoming signal an echo signal to determine echo delay. A preprocesssor extracts a characteristic pattern such as a binary pattern derived by thresholding an averaged power of each signal. This pattern is down sampled then used for the correlation, and delay is deduced from peaks in the correlation. Advantages include reduced computational load, or larger correlation window size, because the characteristic pattern is easier to correlate. The quantising can enhance the correlation peaks, and the averaging can limit the number of transitions, to give more robustness to noise. An echo canceller has a coarse echo delay estimator and a fine echo delay estimator. The coarse estimated delay is used to adjust a delay detection range of a fine delay detector having a narrow range. The output of the fine detector is used to adjust or suppress the adaptive echo canceller.

### FIELD OF THE INVENTION

The invention relates to methods and apparatus for detecting delays in echoes, to echo cancellers having such apparatus, to central offices having such echo cancellers for use in telecommunications networks, to methods of providing telecommunications services using the above, to corresponding software and to systems incorporating the above, and corresponding methods.

### BACKGROUND

There are various known signal processing methods for determining a delay of an echo (also termed echo ranging). As well as being useful for echo cancellation, it is useful in a wide variety of applications such as geology, oceanometry, mobile GSM and CDMA, radar target locating, underwater object location, and in particular at receivers of antenna arrays when multi-path reflections are detected. For the different applications, the principles are the same but implementation requirements or constraints may differ. In case of the geology or seismology, for mapping underground strata for oil & gas sources, speed of processing or calculation complexity are not so important. In contrast, real-time processing is needed for applications such as mobile network antennas, or target location in a radar system. For echo cancellation (EC) of telecommunication signals such as telephone calls, the main constraints are speed of detection and computational load, and at the same time accuracy and reliability are also as important. These requirements make the design very demanding.

Two main factors contribute to the generation of echo: acoustic echo between the earphone and microphone of a telephone set, and electrical echo generated in the transmission systems for the transmit and receive directions of the connection. Hybrid circuits (two-wire to four-wire transformers) located at terminal exchanges or in remote subscriber stages of a fixed network are the principal-sources of electrical echo. Subscriber lines in a fixed network are normally two-wire lines for reasons of economy. Interexchange lines, on the other hand, are four-wire lines.

There are two principal known types of delay detection algorithms for such applications, adaptive filtering and algorithms using a subband filter with a sinc function. An example of the former, adaptive filtering for echo delay estimation, or echo location, is shown in Canadian Patent application 02319639 (Popovic). This uses an adaptive filter to model the echo using a downsampled version of the echo source to The adaptive filter generates an aliased transfer function having peaks corresponding to the delay of the echo. An example of the latter is shown in “implementation and evaluation of a real-time line echo bulk-delay estimator” by Ramkumar et al, published in 2000 by IEEE, ref 0-7803-6293-4/00.

Although echo cancellation systems have been implemented without delay detection, it will play an ever more important role in echo canceller (EC) systems for the following reasons. The actual echo delay can be exaggerated by newer cascaded networks. For example in cases of ATM (Asynchronous Transfer Mode) or GSM (Global System for Mobile) networks, the round trip could be 80-200 ms. This would make the echo more pronounced and more noticeable. In such case if the echo tails are delayed beyond the scope of the EC capability, and the EC is not switched off temporarily, it could have very undesirable effects such as distortion, or additional unpleasant sounds, such as howling. In other words the EC as a system may rapidly become unstable.

There are two main objectives in detecting the delay, which are:

determining if the delay is within the required range, so that amongst other things, the EC can be adapted or switched off rapidly if it is out of range, and

if within range, estimating a value within±τ ms for the echo delay, so that the EC can be adapted more effectively.

The known methods do not achieve these or do not achieve them with sufficiently low computational load, or short processing time, with appropriate accuracy and reliability.

It is known in principle from U.S. Pat. No. 4,577,309 (Barazeche et al.) to use correlation to determine echo delay, but only for the purpose of setting a variable delay in the canceller, and only by adding special autocorrelation signals. U.S. Pat. No. 5,737,410 (Vahatalo et al.) shows correlating speech signals to find the echo delay without adding auto correlation signals. It shows reducing the amount of calculation in such a correlation by using a sliding window of samples. This is achieved by updating the echo signal for each correlation, but not updating the original signal. Thus each succeeding correlation is based on an increasingly delayed version of the original signal. This leads to reduced calculation because a shorter window of samples can be used for the correlation, while still detecting delays much longer in duration than the window, as the window effectively slides with time, compared to the fixed window of samples of the original signal. At longer intervals, this fixed window is updated. This is said to be better than using subsampling to reduce the calculation, since subsampling reduces the accuracy of the delay value.

### SUMMARY OF THE INVENTION

It is an object of the invention to provide improved apparatus or methods. According to a first aspect of the invention, there is provided an echo detector having:

a correlator for determining a correlation between an incoming signal an echo signal having an echo of the incoming signal, and

a preprocesssor for extracting a characteristic pattern from the incoming signal and a characteristic pattern from the echo signal,

the correlation being determined by correlating the characteristic patterns, and the detector being arranged to detect the echo from peaks in the correlation.

The term characteristic pattern is not intended to encompass a low pass filtered version of the original signal such as that obtained in the above mentioned prior art by down sampling. Advantages of using a characteristic pattern for the correlation can include improved robustness to noise, reduced computational load, or larger correlation window size. These advantages can arise because the characteristic pattern is easier to correlate than the original signal. The pattern can contain more of the information in the signal which is useful for the correlation, and less of the information which is not useful for the correlation. As a result, the correlation output can provide clearer, more distinct peaks, with fewer false peaks to mask the peaks resulting from the echoes. Also, this can enable more down sampling before correlation, to reduce the computation load of the correlation, which is particularly useful for coarse estimation of echo delay.

As a preferred additional feature, the characteristic patterns can be based on a quantised average of the respective signal or its power. In this case, the quantising serves to enhance the correlation peaks, and the averaging can serve to limit the number of transitions, to give more robustness to noise.

As another preferred feature, the quantisation can be into a binary form, using a threshold.

As another preferred feature, the characteristic patterns are down sampled before the correlation. This can reduce the computation load. In many cases, such patterns can be down sampled much more than the original signals without undue loss of reliability of correlation. Such down sampling still causes a loss of precision of echo delay estimation, and so may be limited in some applications.

As a preferred additional feature, the detector is arranged to determine a delay of the echo from the correlation.

As another preferred additional feature, the correlation is arranged to be carried out recursively, using results obtained for preceding correlation values for determining a current correlation value.

An advantage of such recursive operation is that a dramatic drop in calculation is possible. In one example, the amount of calculation drops from being proportional to N*N, to being proportional to 2N, where N is a number of samples in a correlation window. N can be a value in the order of hundreds in a typical application. Consequently there may be a corresponding reduction in computation delay. Depending on the recursive algorithm, the load may now be proportional to the number of samples correlated, rather than the square of the number of samples. Again, depending on the recursive algorithm, there may be some loss of accuracy, especially in the first few frames if the algorithm produces an approximated correlation value rather than precisely the same result as a non recursive algorithm. For many applications, the dramatic drop in computational load, and thus faster output of results is much more valuable.

As an additional preferred feature, the correlator is arranged to derive a current correlation component by correlating a current sample value of the characteristic pattern of the echo signal and a window of samples of the characteristic pattern of the incoming signal.

This feature helps enables the computational load to be kept low, by reducing the number of multiplications.

As a preferred additional feature, the characteristic patterns can be based on zero crossings of the respective signal. This can also enable the correlation peaks to be enhanced.

As a preferred additional feature, the characteristic patterns can be based on auto correlation functions of the respective signal. This can also enable the correlation peaks to be enhanced.

As a preferred additional feature, the characteristic patterns can be based on pitch. An advantage of using pitch for the correlation is that it can enable a more accurate and reliable detection of the echo. In particular, the detection can be more independent of signal level, more robust in the presence of noise. Alternatively, the correlation update rate can be reduced further, since human pitch normally does not change as rapidly as the entire signal. Typically it will not change over periods of 25-60 msecs This can outweigh the additional computational load and delay involved in determining the pitch.

The term correlator here is intended to encompass anything which determines a similarity between the pitch of the two signals. Where the signal is an unvoiced part of speech, with no pitch, this still can be used for the correlation, since the correlator can distinguish occurrences of similar lack of signal from non similar higher level signals.

Another aspect of the invention provides an echo canceller having such a detector. As a preferred additional feature, the canceller is arranged to be suppressed depending on an output of the echo detector.

As a preferred additional feature, the canceller is arranged to adapt depending on an output of the echo detector.

As a preferred additional feature, the canceller has an adaptable range of echo delay, the range being adaptable depending on an output of the echo detector.

As a preferred additional feature, the detector or the echo canceller is in the form of software. This recognises the value of software as a component which may have great value and be independently traded, separately to hardware components.

Another aspect of the invention provides central office apparatus having the above echo canceller. Another aspect of the invention provides a method of providing a telecommunications service to subscribers, over a network, and using the above central office apparatus.

Another aspect provides an echo detector having a coarse echo delay estimator and a fine echo detector, each arranged to detect echoes having delays within a given range, the range of the coarse detector being wider than the range of the fine detector, the range of the fine detector being adjustable according to an echo delay determined by the coarse echo delay estimator.

An advantage of this is that a better balance between accuracy of detection, extent of range, computational load and computational delay, can be achieved. In particular, this can enable the range of the fine detector to be reduced, thus reducing computational load and delay, and/or improving accuracy.

As a preferred additional feature, a centre of the range of the fine detector is adjustable.

As an additional feature the coarse echo delay estimator has a correlator for determining a correlation between an incoming signal an echo signal having an echo of the incoming signal, and a preprocesssor for extracting a characteristic pattern from the incoming signal and a characteristic pattern from the echo signal, the correlation being determined by correlating the extracted characteristic patterns, and the detector being arranged to detect the echo from peaks in the correlation.

As another preferred feature, the characteristic pattern is based on a quantised average of the signal or its power.

As another preferred feature, a delay value output by the coarse echo delay estimator is compared to a current range of the fine echo detector, and the result is used to confirm an echo detection output of the fine echo detector.

Another aspect provides an echo canceller having the above echo detector, and arranged to suppress a cancellation action on the basis of an output of the coarse echo delay estimator.

As a preferred additional feature, the canceller has a filter for filtering the incoming signal to model the echo, a centre of a window of the filter being adjustable on the basis of an output of the coarse echo delay estimator.

As a preferred additional feature, the centre of the window is adjustable by providing an adjustable delay for delaying the incoming signal before it is input to the filter.

Other aspects provide for methods or software corresponding to any of the apparatus or system aspects, or combinations or components of the above aspects. Other advantages than those set out above may be apparent to those skilled in the art, particularly over other prior art of which the inventor is not yet aware. The features of dependent claims within each aspect can be combined with each other or with other aspects of the invention as would be apparent to those skilled in the art.

### BRIEF DESCRIPTION OF THE FIGURES

Embodiments of the invention will now be described with reference to the figures as follows:

FIG. 1 shows in schematic form echo cancellers in a known network,

FIG. 2 shows in schematic form an arrangement of an echo canceller having a delay detector,

FIG. 3 shows a delay detector,.according to an embodiment of the invention, having a correlator using extracted characteristic patterns,

FIG. 4 shows an embodiment in which the extracted patterns are quantised average powers,

FIG. 5 shows another embodiment showing how the quantised average power can be extracted and used,

FIG. 6 shows another embodiment in which the extracted patterns are zero crossings

FIG. 7 shows another embodiment in which the extracted patterns are auto correlation functions,

FIG. 8 shows another embodiment in which the extracted patterns are the pitch of the signals,

FIG. 9 shows an example of how the pitch can be extracted.

FIG. 10 shows an embodiment of an echo canceller having a coarse delay estimator and a fine echo delay detector,

FIG. 11 shows more details of a delay detector implementation according to another embodiment,

FIG. 12 shows more details of an implementation of the recursive algorithm shown in FIG. 11, and

FIG. 13 shows an example of how to implement a classifier for processing the correlation results.

### DETAILED DESCRIPTION

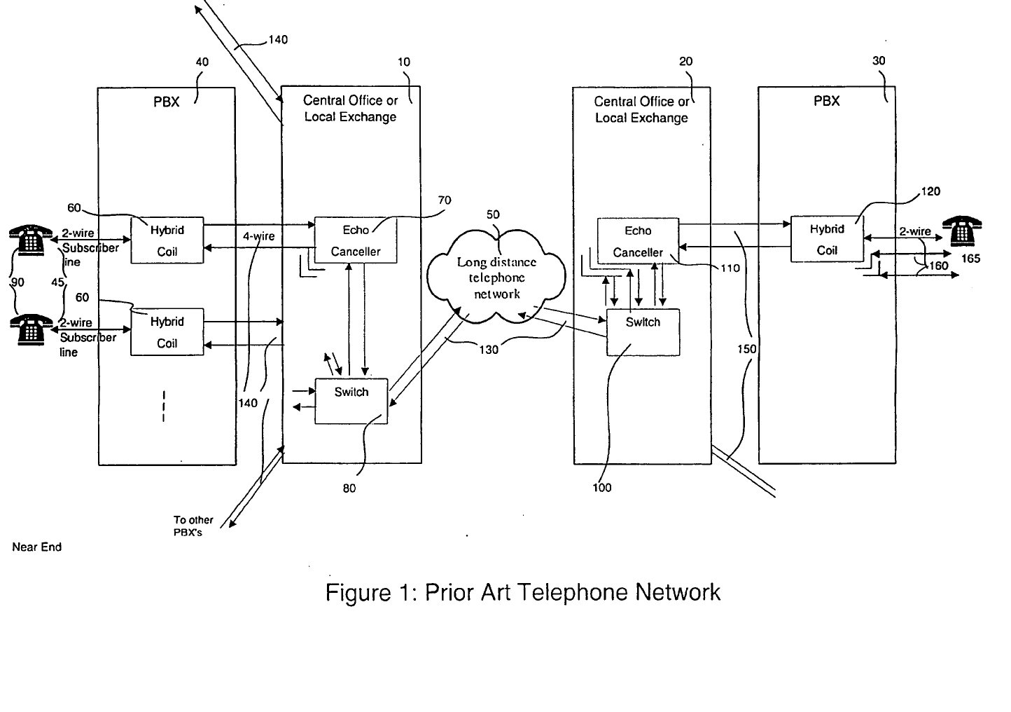

FIG. 1, Showing How Echo Cancellers are used in Conventional Telephone Networks

FIG. 1 shows an application of the echo canceller of the invention in a conventional telephone network. In this figure, a long-distance telephone network 50 is shown, for making a telephone call from one subscriber to another. For convenience, one side of the network is denoted the near end, and the other side is denoted the far end. A subscriber's handset 90 is coupled to a private branch exchange (P B X) by a 2-wire subscriber line 45. In the P B X, a hybrid coil 60 is used to convert between the two wire subscriber line and a 4-wire line to the Central Office or local exchange 51. The conversion to 4-wire enables the voice signals in two directions to be a separated, which is useful for digitising and further processing. Each P B X may support tens or hundreds of subscribers, and will have sufficient hybrid coils according to how many calls are to be supported simultaneously.

Connections from many PBXs and many subscriber lines may be concentrated at a Central Office 10, which maybe many miles away from the subscriber. The central office contains the echo canceller 70, and a switch 80. For the sake of clarity, many other functions of the Central Office are not illustrated. There may be many echo cancellers provided, according to how many calls are to be handled simultaneously. Conventionally, each Central Office concentrates many calls on to one or more or trunk routes 130 which make up the long distance telephone network 50. At the far end, similar elements and functions are provided. A far end Central Office 52 contains an echo canceller 110 and a switch 100. 4-wire lines 150 are provide to connect the Central Office to one or more P B Xs 53. Each will contain a hybrid 120. Two-wire subscriber lines 160 couple handsets 165 to the hybrid.

As the echo cancellers are intended to cancel echoes arising from the hybrids at each end of the circuit, in principle, they can be located anywhere in between the hybrids. They are in practice usually located in a central office where many lines are switched and concentrated. This is convenient to enable them to be shared to make more efficient use of limited processing resource, and for ease of access.

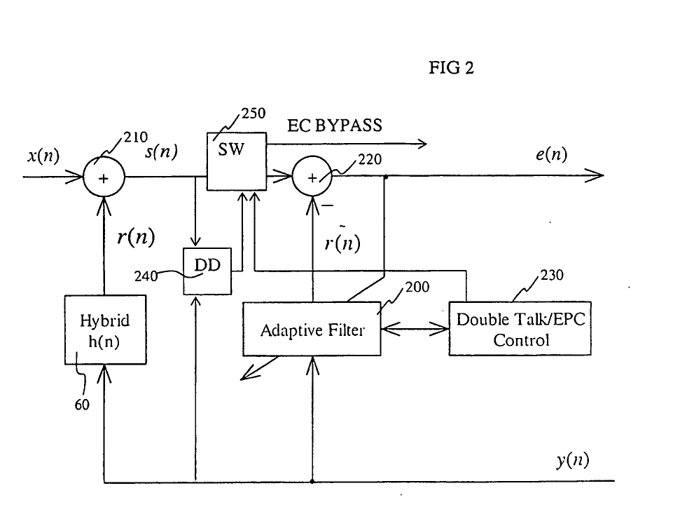

FIG. 2, Showing Principal Elements of an Echo Canceller with a Delay Detector DD

In FIG. 2 a near end signal x(n) has an echo added by a hybrid 60. The hybrid has an impulse response h(n). An adder 210 is shown to represent schematically the addition of the echo r(n) to the near end signal, resulting in an echo signal s(n). The principal elements of the echo cancellor shown in FIG. 2 are an adaptive filter 200, a double talk/EPC (echo path change) control element 230, a delay detector (DD) 240, and bypass switch 250, and a subtractor 220. The adaptive filter creates a model echo r(n) from an incoming signal y(n) also termed a far end signal. The model echo and the echo signal are fed to the subtractor. The model echo is subtracted from the echo signal to produce an echo cancelled signal e(n).

The bypass switch 250 enables the echo signal to bypass the subtractor. This can be achieved by a switch before the subtractor, or a switch after the subtractor, as would be well known to those skilled in the art. The bypass switch is controlled by the delay detector or the double talk/EPC control element. In both cases, the purpose is to avoid or reduce distortion in particular circumstances. Other detectors not shown may also trigger a bypass, such as tone detectors. The delay detector can also be arranged to influence the adaptive filter.

The delay detector is arranged to receive the echo signal from the near end and the incoming signal from the far end. It is arranged to carry out the correlation between these signals to detect echoes and determine echo delays. Some examples of delay detectors will now be described in more detail.

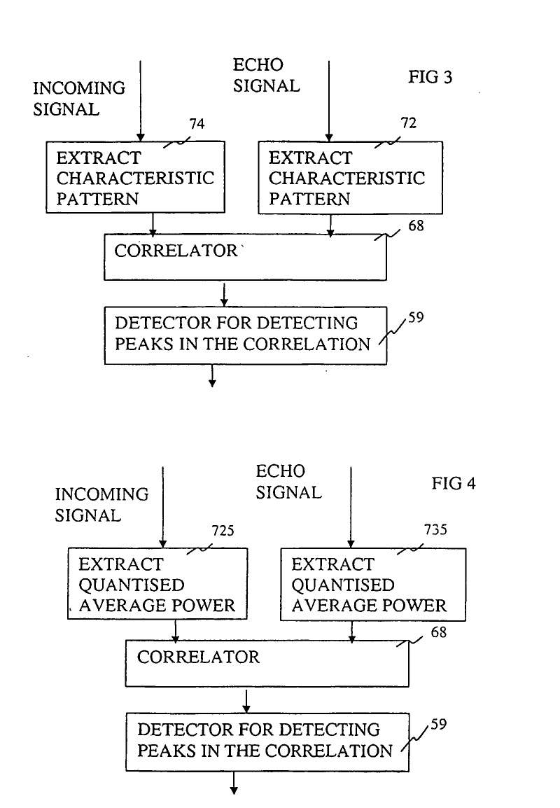

FIG. 3, Showing an Embodiment of the Delay Detector Having a Characteristic Pattern Extractor.

FIG. 3 shows in schematic form principal elements of a delay detector according to an embodiment of the invention. This embodiment can be used to implement the delay detector of FIG. 2. The incoming signal and the echo signal are fed to preprocessors in the form of extractors 72, 74 for extracting a characteristic pattern from the echo signal and the incoming signal respectively. The values of the characteristic pattern extracted, are fed to a correlator 68. The output of the correlator is fed to a detector 59 for detecting consistent peaks in the correlation. The consistent peaks provide an indication of echoes, and the index of each consistent peak indicates the echo delay for each echo.

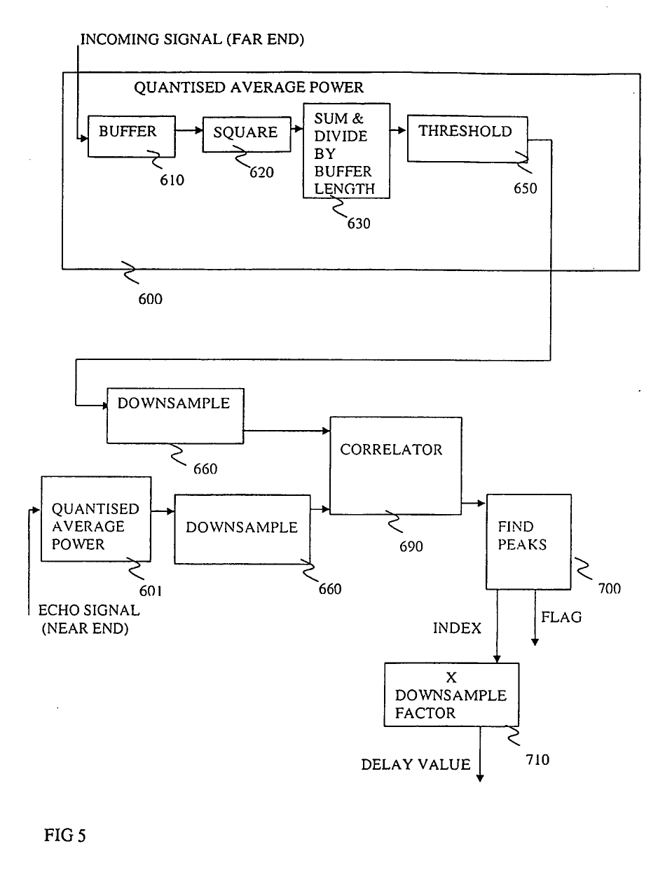

FIGS. 4,5, Embodiments using Correlation of Quantised Average Power

FIG. 4 is as FIG. 3, but where the characteristic pattern is the quantised average power, extracted from the incoming signal and the echo signal respectively by elements 725 and 735. A more detailed embodiment is shown in FIG. 5. This way or other ways can be used to implement the arrangement of FIG. 4. As shown in FIG. 5, a quantised average power is determined for each of the incoming signal and the echo signal, by elements 600 and 601 respectively. The output of these elements is a binary pattern. Components making up this element are shown for element 600 and omitted for element 601, for the sake of clarity. These components include a buffer 610 for converting a serial stream of 8 kHz samples into a frame. This is effectively a serial to parallel convertor. These vectors are output at the 8 kHz sampling rate, (or optionally a slower rate) and so each vector contains a fixed number of samples N which appeared in the preceding vector, but are shifted one place, together with one new sample. In other words there is N-1 samples of overlap between the vectors. In a typical example, N is 128.

Each sample in each vector is squared to make them all positive and proportional to signal power, in element 620. As there is so much overlap, the squaring function can be carried Out recursively using the results from the squaring of the preceding vector, and adding a square of the most recent sample, and subtracting the square of the oldest sample. In element 630, an average value for the whole vector is obtained by summing these squares, and dividing by the length of the vector. At element 650, this average value is quantised by threshold element 650. (Optionally this value can be converted to a dB value before thresholding.) This produces a binary value. In principle, the quantisation could be multi level, using multiple thresholds. The threshold level can be adaptable, and is selected to give enough transitions to give a good pattern for reliable correlation. In a typical example this threshold could be −40 dB, equivalent to a barely audible speech level. The averaging over a whole vector of N samples helps reduce susceptibility to noise. In principle, the power could be averaged without quantisation, or quantised without averaging, but in practice, the combination produces better results. Also, signal level or some value derived from signal level could be used other than signal power.

Before correlation by element 690, optionally, both quantised average powers can be downsampled by element 660, in other words, decimated, to reduce the computational load in the correlator. The amount of decimation may depend on the accuracy of delay value required. For a coarse echo delay detector, decimation may be by a factor of up to 64, and still have enough information to give reliable correlation. The use of a characteristic pattern rather than the original signal enables much more decimation than could be achieved using the original signal. This enables the correlation window to be much longer for a given computational load. The correlation window length determines the range of echo delays that can be detected, which is a significant constraint in previous echo detectors.

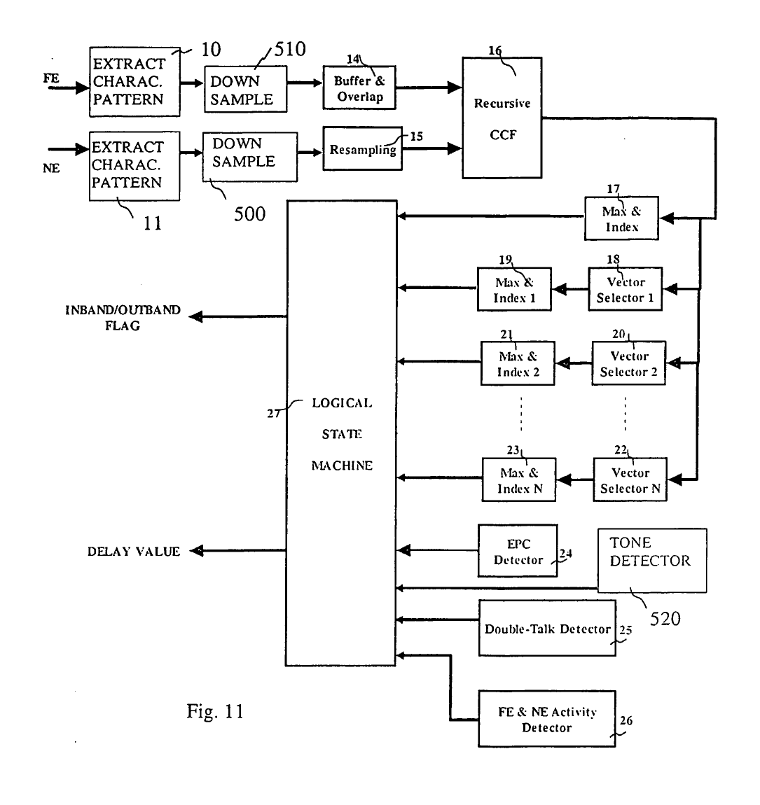

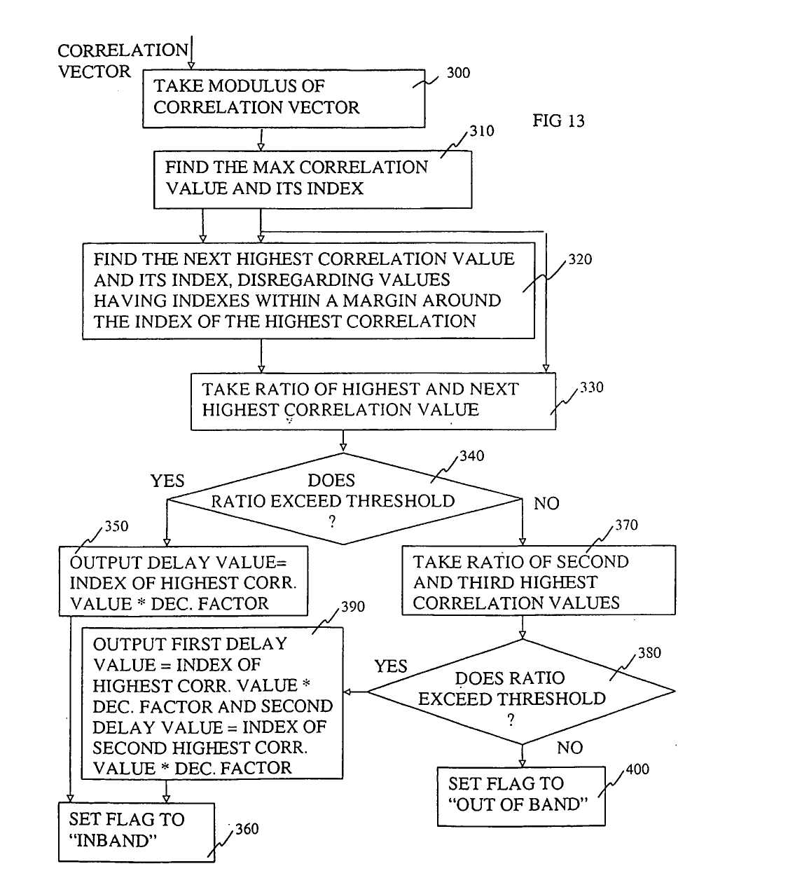

The correlator 690 can be any conventional correlator, but preferably is a recursive type as described below in more detail. The output of the correlator will be a vector, updated at a given rate. In this case if the window length is 128 (decimated) samples (i.e. 1024 msec), whose rate is 8 Khz divided by 64=128 Hz, the output correlation vector or frame will also be 128 samples long. Element 700 finds consistent peaks in this vector. This can be done using the classifier described below with reference to FIGS. 11 and 13, or any type of conventional peak detector. The outputs of the peak detector are a flag to indicate a peak, and an index indicating the position of the peak value in the vector. This index is multiplied by the downsampling factor using element 710, to output a delay value. As mentioned above, these outputs can be used in many applications. In echo cancelling applications, they can be used to vary an adaptive filter, by varying the coefficients, or delaying the input for example, or suppressing the cancellation by a bypass or similar operation.

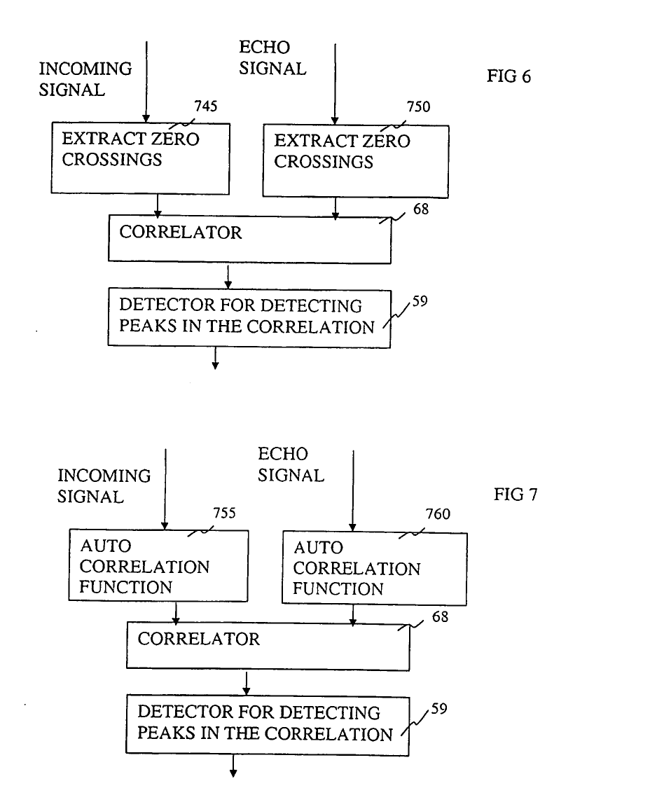

FIGS. 6 and 7, Other Examples of Characteristic Patterns.

FIG. 6 corresponds to FIG. 4 or FIG. 3, where the characteristic pattern is another quantized pattern, this time based on zero crossings of the signals. Corresponding reference numerals have been used as appropriate. A zero crossing extractor 745 operates on the incoming signal, and a similar extractor 750 operates on the echo signal. FIG. 7 also corresponds to FIG. 4 or FIG. 3, where the characteristic pattern is based on an auto correlation function. This may be thresholded to give a quantised pattern. Corresponding reference numerals have been used as appropriate. A first auto correlation function 755 operates on the incoming signal, and a similar one 760 operates on the echo signal. These auto correlation functions can be implemented following established design principles. Other types of characteristic patterns can be conceived with similar advantages.

FIG. 8, Showing an Embodiment of the Delay Detector Having a Pitch Extractor.

FIG. 8 shows in schematic form principal elements of a delay detector according to an embodiment of the invention. This embodiment can be used to implement the delay detector of FIG. 2. The incoming signal and the echo signal are fed to extractors 770, 765 for extracting a pitch value from the echo signal and the incoming signal respectively. The values of the pitch, are fed to a correlator 68. The output of the correlator is fed to a detector 59 for detecting peaks in the correlation. The consistent peaks provide an indication of echoes, and the index of each peak indicates the echo delay for each echo.

Pitch Extraction

As described in U.S. Pat. No. 6,035,271 to Chen, pitch extraction has been well known as an essential part of speech signal processing for decades. Traditionally, pitch is defined as the fundamental frequency of the voiced sections of a speech signal. Three methods are typically used for pitch extraction: autocorrelation, cepstrum, and subharmonic summation, as described in text books on the subject such as Wolfgang J. Hess, “Pitch Determination of Speech Signals Algorithms and Devices” Springer-Verlag, Berlin, 1983; and L. R. Rabiner and R. W. Schafer, “Digital Processing of Speech Signals”, published in 1978, ISBN 0-13-213603-1.

In the book “digital processing of speech signals” by Rabiner & Schafer, there is discussion of pitch period detection at Pages 314-319, 372-379 and 150-158. Various ways of determining pitch period are known, including an impulse train algorithm shown at Page 136, which is very computationally intensive, a Fourier representation technique shown at Page 314 onwards, and an auto correlation function approach using centre clipping, shown at Pages 150-158. For example, using the autocorrelation method, the most prominent peak is identified with pitch. However, in many cases, the peak is at frequencies other than the expected pitch. In fact, if a signal contains sinusoidal components of fundamental frequency and its harmonics, then the peaks in the autocorrelation function can be at many different times.

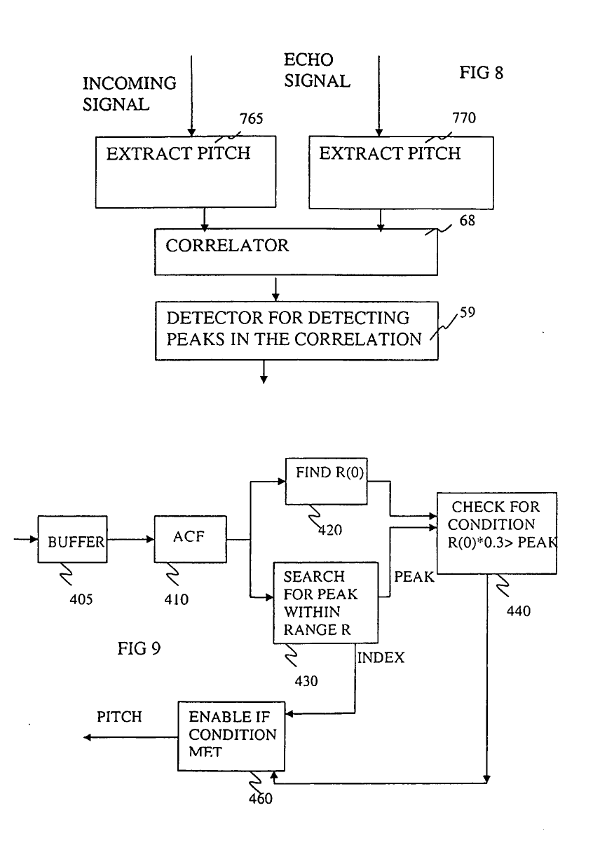

FIG. 9, Pitch Extractor

An example of how to implement the pitch extraction will now be described with reference to FIG. 9. It can be implemented in other ways, as mentioned above. In this embodiment, an auto correlation function (ACF) method is preferred. This involves comparing the samples from the frame with a delayed version of the same frame, and determining how closely they match. The matching can be done by multiplying each sample with a respective delayed sample, and summing the products to obtain one correlation value for each delay. Where there are N samples in the frame, the correlations can be carried out with up to 2N different offsets or delays. To obtain a complete correlation profile, a correlation value should be obtained for each of these 2N different offsets. This can be implemented using a buffer 405, then feeding a frame to the ACF function 410. Any peaks in this correlation profile can represent pitch periods, if the peaks are above a certain threshold, and the offset or delay that results in the peak, is the pitch period value.

For determining the presence of such pitch periods to detect echoes of voice or tones, it is not necessary to calculate the correlation profile over the entire range of offsets. A range of 3 to 14 milliseconds of offset will be sufficient to cover all the frequencies of interest in the speech. Since determining the correlation profile is computationally intensive, a valuable reduction in the amount of calculation can be achieved by limiting the range of offset for which the correlation profile is determined. The profile is analysed by element 430 to determine if there are any peaks that would indicate the presence of a pitch period. Provided the peak has a magnitude of greater than a threshold such as one-third of the normalised maximum signal power, determined by element 440, the decision is made that a pitch period is present in that frame. The normalised maximum signal power may be represented as R(0), as shown in element 420 in the figure. The result in terms of a quantized value for the presence of a pitch period is then output.

Where a pitch period has been detected, then a value for the pitch period is output by element 460, in terms of the offset, also called index, at which the peak was detected. The two pitch period signals extracted from the incoming signal and the echo signal are then correlated, to find consistent peaks corresponding to echoes.

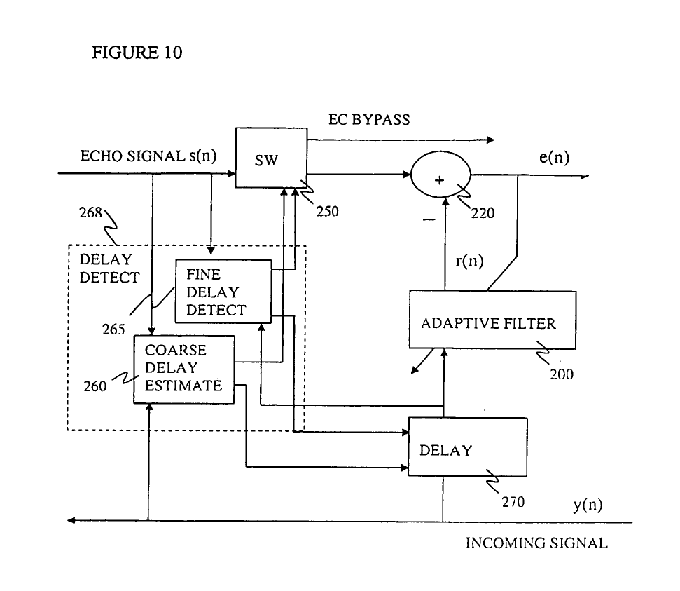

FIG. 10, Canceller Having Fine Echo Detector and Coarse Echo Delay Estimator

FIG. 10 shows in schematic form elements of an echo canceller according to an embodiment of the invention, similar to the arrangement shown in FIG. 2. Corresponding reference numerals have been used where appropriate. The main difference is the delay detector, 268 which has a fine echo delay detect element 265 and a coarse echo delay estimate element 260. The coarse echo estimate element is arranged to determine an echo delay from the echo signal and the incoming signal. This can be implemented using a correlation element or optionally using other well known ways for estimating delays. An example of how it can be implemented is described above with reference to FIG. 5.

As shown in the figure, the delay estimate output from this element is fed to a delay element 270, to adjust a delay applied to the input of the adaptive filter 200 derived from the incoming signal. This has the effect of altering the centre of the filter window, enabling modelling of echoes having a range of delays around the centre delay. Other ways of achieving this are readily available, including altering the filter coefficients directly on the basis of the estimated delay value, or altering the filter window such as by altering the sampling rate.

The outputs of the fine delay are likewise used to control the delay. This can enable finer adjustment of the delay. Notably the inputs to the fine echo delay estimate element are the echo signal and the delayed version of the incoming signal. By using the delayed version, effectively the centre of the range of echo delays detectable by this element is shifted. As this shift is controlled principally by the output of the coarse echo delay estimate element, this is a way of making the range of the fine detector adjustable according to the echo delay, leading to the advantages set out above in the summary of invention section. The fine detector may be implemented using a correlation method, or alternative known methods. Preferably the coarse estimator has a much wider range, and much greater subsampling to reduce computation load, than the fine detector. The fine detector is more concerned with accuracy of the delay value, and subsampling reduces the accuracy. Since the fine detector has an adaptable centre of its range, the breadth of the range can be arranged to be much shorter. This range is proportional to the correlation window length. The computational load can be reduced for the fine detector by having a much shorter correlation window, instead of subsampling heavily.

The outputs of the delay detector can be used for adjusting the delay 270, and/or for suppressing the cancellation if the delay detector determines there is no echo, or it is out of range (also called out of band). In this case, a bypass switch 220 is provided, to bypass subtractor 220 but alternatives are conceivable, including interrupting the output of the adaptive filter for example. For driving the bypass switch, the “Inband/Outband” flag output by the fine detector and the delay value output by the coarse estimator are combined as follows. If the fine detector flag shows inband, and this is confirmed by the echo delay estimate of the coarse estimator, then the bypass is not operated. If the flag indicates outband, and the delay estimate is invalid or out of range, then the bypass is operated. If there is a conflict, i.e. inband but out of range, or outband but in range, then the default is that the bypass is operated, to avoid disturbing effects such as howling.

The algorithm works like this:

Run DD128 (this is the fine detector, with a 128 msec detection range)

| If inband128-flag is HI (in) | ( i.e. this is the output of the fine |
|---|---|
| | detector) |

Adaptive filter (AF) is ACTIVE

Else

| | |
|---|---|
| Run the long DD1024 | (i.e. this is the coarse detector with |

a 1024ms detection

range)

| | |
|---|---|
| If inband1024 is HI | (i.e. there is a delay >128ms but <1024) |

Then the small DD128 can be moved to there, centred or
bypassed
switch if they don't want to use the DD128

else

go to bypass switch

In a typical implementation of a coarse delay estimator using the arrangement of FIG. 5, the subsampling factor can be as high as 64, the correlation window can be 128 samples long, The range can extend to 1024 msecs, well beyond the usual limit of 128 msecs of known systems (this increase the range of the delay detector by factor of 8 with practically the same amount of computation as a 128 msec range detector).

FIG. 11, Showing a More Detailed View of a Delay Detector.

More details of one example of how to implement the detector 75 for detecting peaks in the correlation, and then classifying the peaks, is shown in FIG. 11. This arrangement can be used as a complete delay detector, or as a fine detector, or as a coarse delay estimator. The choices of characteristic pattern, of correlation frame length and of downsampling factor, and of sophistication of the classifier, can be made to suit the application. To detect distinct peaks, a time margin around the highest peak can be used. A next highest peak outside the time margin is detected. Other peaks within the time margin are disregarded. This takes account of the common situation of an echo causing several closely spaced peaks in the correlation. The widely spaced peaks can represent echoes with widely differing delays. The peaks are fed to a classifier for classifying the peaks as shown in FIG. 11. In particular, the classification may include whether the peaks represent an echo which is suitable for cancellation, or periodic signals or other artefacts which might cause the echo canceller to become unstable, or degrade its output. Again, various implementations of each of these elements are possible, as will be explained in more detail below.

In FIG. 11, inputs to the delay detector include an echo signal from the near end (NE), and an incoming signal from the far end (FE). The outputs include an inband/outband flag to indicate an echo which is suitable for cancellation, and one or more delay values corresponding to the echo or echoes detected. The echo signal from the near end (NE) is fed to a characteristic pattern extractor 11. The output is downsampled (decimated) by element 500 (having a decimation factor D, which can be 4 in one example). If the decimation is by a factor of 4, then for an original sampling rate of 8 kHz, becomes a decimated sampling rate of 2 kHz. This enables a frequency range of 1 kHz to be represented.

The incoming signal is similarly fed to a characteristic pattern extractor 10. The pattern output is fed to a downsampling element 510. Both downsampled characteristic patterns are fed to a recursive correlator 16 to give a cross correlation factor (CCF). In the case of the incoming signal pattern a buffer and overlap function 14 is provided before input to the correlator. The buffer function enables a window of consecutive samples of the pattern to be presented as a vector to the correlator. The overlap indicates that consecutive vectors are formed from overlapping windows of samples.

The echo signal pattern is fed to the correlator via a resampling element 15. This provides a delay to synchronise the signals, and reflects the correlation update rate, M which may be lower than the decimated sample rate to reduce the calculation load. No buffering is provided for this signal, since the recursive correlator can operate on just the current sample value of the characteristic pattern of the echo signal, without necessarily needing a vector of consecutive samples. An automatic gain control stage may be provided, (not shown in this figure).

A modulus of the vector produced by the correlator is derived and fed to classifying stages 17-23,27. The modulus is derived so that positive or negative correlation peaks have the same effect. An updated vector is fed to the classifying stages every M samples. For each vector, first, a maximum and index finder 17, is used for determining a maximum peak in the entire vector, and a corresponding index (which represents the delay at this peak). These are used to control a series of vector selectors 18, 20, 22. These are used to determine the next highest peaks in parts of the correlation away from the highest peak. These parts may be omitted optionally, if it is not desired to track multiple echoes, by detecting multiple peaks. The vector may be divided into quarters or some other fraction. A first quarter can be centred on the index of the maximum peak, and other quarters or parts of quarters derived from the index of the maximum peak. Vector selectors 18, 20, 22 and so on are each used to carry out this segmentation, and feed the selected part of the vector to their associated maximum and index elements 19, 21, 23.

These elements determine the highest peak in their quarter, or part of the vector, and the corresponding index value. This segmentation of the vector enables search time for the next highest peaks, and computational load to be reduced. The detailed implementation of these elements is a matter of design convenience following established practice.

The outputs of these elements are fed into a logical state machine 27 which determines ratios of magnitudes of successive distinct peaks separated by time margins of R samples. (In a typical example, R=15). The ratios are thresholded, and if they show the ratio is large enough, the echo is flagged as inband. The flag can also show whether more than one distinct peak has been identified. The delay value represented by the index of the respective peak is derived by determining a product of the decimation factor and the index. Where multiple echoes are detected, multiple delay values can be output by the logical state machine.

Optionally, the logical state machine may have other inputs for controlling the flag output. Examples include the EPC detector 24, the double-talk detector 25 and the FE and NE activity detector 26. A tone detector 520 may be useful so that if a tone is detected, the state machine should be disabled or indicate that the correlator output cannot distinguish between echo or no echo. The flags can be arranged to indicate a “don't know” condition, and any delay value will be unreliable in this case. Normally the classifier will show no echo, because the correlator output will not show a sufficiently distinct peak. But this may mask the fact that there is an undetected echo.

Recursive Correlator

The correlator may be a recursive correlator, and such a correlator will now be described in more detail. The cross-correlation of the two signals NE and FE is calculated as in following equation for the correlation vector, termed the cross correlation factor ccf.

$$ccf ( k ) {\vert}_{t = τ} = {\sum }_{n = 0}^{N - 1} y ( n ) \cdot s ( n + k )$$

The MIPs (Million Instructions per second) consumption of the above equation is of factor of N (the length of the correlation window, measured in samples), where in our case N=1024, and a sampling rate of 8 kHz, i.e. about 8000 MIPS

(1024*1024*8000*10⁻⁶≈8388). In order to reduce the computational the following measures can be taken:

a. Use a recursive algorithm for CCF.

b. Sub-rating (also called decimating) the FE and NE signals by a factor of D.

c. Different updating rate of the correlation, by a factor of M of the decimated samples. In other words, successive correlation windows overlap not by all but 1 decimated sample but by all but M decimated samples.

For example using measures b and c, D=4 and M=2, MIPS consumption will be reduced to {256*256*8000*10⁻⁶/(4*2)≈65}. This is still an unrealistic computational load for many applications. To make above ccf equation realizable a recursive algorithm can be used to make a much greater impact on the computational load. An example of a recursive algorithm now follows:
CCF|ₙ=1/Q (Y|ₙ.s(n))+(1−1/Q) CCF|₍ₙ₋₁₎
where Yₙ=y(n)+y(n-1)+A+y(0)
and CCF|ₙ=ccf(n)+ccf(n-1)+Λ+ccf(0) n=0,1,2,Λ,N-1

Q is the span factor which represents how much of the preceding ccf to remember. Using this equation will reduce the computation drastically. For example with use of D=4, and M=2, the MIPS consumption will be: {256*2*8000*10⁻⁶/(4*2)≈0.512} which is not only realistic, it is a considerable improvement on other known methods. For a coarse detector with D=64 and M=1, this would give 128*2*8000/64=0.032 MIPS which is even more dramatic.

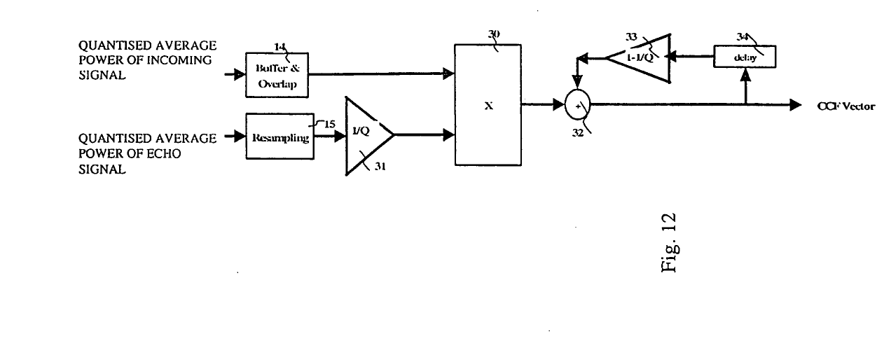

FIG. 12, Showing a More Detailed View of the Recursive Correlator.

In FIG. 12, reference numerals corresponding to those in FIG. 11 where appropriate. The echo signal and incoming signal are processed as shown in FIG. 11 up to the point where they are input to the recursive correlator. As shown in FIG. 12, the incoming signal in the form of a vector output by the buffer and overlap element 14 is fed to a multiplier 30. The echo signal as output by the resampling element 15 is amplified by a constant factor I/Q in element 31. This result is fed to the multiplier and multiplied by the incoming signal vector. This produces an instantaneous correlation vector, but only in respect of the current echo signal sample.

Resampling is effectively for synchronising the inputs of the correlator, since the buffer and overlap element introduces a delay. Resampling also effectively decimates the signal further, by a factor of M, to match the reduced rate of the output of the buffer and overlap element.

To correlate a window of echo signal pitch samples with a window of incoming signal pitch sample signals, the instantaneous correlation vector is added to preceding instantaneous correlation vectors. To achieve this recursive function, an adder 32, an amplifier 33 and a delay element 34 are provided. The instantaneous correlation vector is added to a delayed version of the output of the adder. The delayed version is amplified by a constant factor 1-1/Q before input to the adder. The amplifiers 31 and 33 may be used for AGC purposes as well. The output of the adder 32 may be used to feed an element (not shown) for deriving a modulus of the vector.

FIG. 13. Showing Operation of the Classifier.

FIG. 13 shows in schematic form some of the principal steps in the operation of a classifier such as that shown in FIG. 11. As shown in FIG. 13, the correlation vector is first fed to a modulus function 300 so that positive or negative correlation peaks are not treated differently. Step 310 takes the modulus and finds a maximum correlation value and its corresponding delay. At step 320 the next highest correlation value is determined disregarding peaks having delays within a margin around the delay value of the highest peak. At step 330, the peaks are classified by taking a ratio of the highest correlation value and the next highest correlation value. At step 340, the ratio is thresholded and if it exceeds a threshold, at step 350, a delay value is derived and output. It is derived by generating a product of the index and the decimation factor D.

At step 360, the flag is set to inband. Although it is possible to look for further peaks, if the threshold ratio is around 1.5 or greater, there will be limited benefit for echo cancellation applications at least, in looking for lower peaks. In contrast, if the threshold is not exceeded, it is more worthwhile looking for the ratio of the two next highest peaks. Hence at step 370, a ratio of the second and third highest peaks is derived. At step 380, it is compared to a threshold, typically but not necessarily the same threshold as before. If the threshold is exceeded this time, two delay values are output at step 390, corresponding to the two highest peaks. As before, they are derived by multiplying the index value corresponding to the peak, with the decimation value D. Also, at step 360, the flag is set to “inband”. If the threshold is not exceeded, the flag is set to “outband”.

In principle, further echoes could be classified and flagged in a similar manner, though with decreasing additional benefit in terms of echo cancellation performance. Other applications may benefit from classifying other weaker echoes.

In other words, the method can be summarised as follows:

a. Take the modules of the CCF vector, i.e. |CCF|

b. Find the max index and the value of the max, CCF_{max1Index} and CCFₘₐₓ₁,

c. Find the second max outside the specific range (R), i.e. CCF|n±R as CCF_{max2Index} and CCFₘₐₓ₂. This is done since if the FE and its delayed echo is present within the search range, an exponential decay behaviour of CCF per hybrid is expected.

d. Calculate the ratio and threshold it: CCF_{max1Index}/CCF_{max2Index}≧RATIO

e. If the statement ‘d’ is TRUE then it is flagged as INBAND otherwise:

f. find the third max outside the specific range (R), i.e. CCF|n±R as CCF_{max3Index} and CCFₘₐₓ₃.

g. Calculate the ratio and threshold it: CCF_{max2Index}/CCF_{max3Index}≧RATIO.

h. If the statement ‘d’ is TRUE then it is flagged as INBAND otherwise flag as OUTBAND.

Other Variations, Comments and Remarks

In a typical application for a fine detector the following parameters can be used for searching for an echo delay of up to 128 ms (1024 ms for a coarse detector):

D=2-8, i.e. buffer of 128-512 samples for a window size N of 1024 samples. (2-64 for a coarse detector)

M=1-6, i.e. overlap of 250-255 if the buffer is 256 samples.

Q=512, (64-512 for a coarse detector)

RATIO=1.5-2.1,

R=10-25 samples.

Advantages found for the given settings include the MIPS and memory consumption being very low, i.e. for a fine detector <1 MIPS and memory usage of less than 1 kwords, where the word size depends on the processor. For a coarse detector these figures can be <0.05 MIPS and <0.5 kWords. The echo detection is not restricted to echoes of speech, it can encompass echoes of other signals such as pulses or tones for example. The tones can include signalling tones of single or multiple frequencies, or any other types of tones.

The echo canceller can be bypassed depending on the echo detector outputs, or in principle, the echo model input to the subtractor can be suppressed. The adaptive filter can be adapted using the echo delay values, and the correlation peak values, or shape. Additionally, the far end signal can be delayed before input to the adaptive filter, to enable a simpler, faster and more efficient filtering operation.

In another embodiment of the EC, the delay value from the delay detector would play a more important rule since, if echo delays (in other words the EC tails) lie in a different range, say from 128 ms to 256 ms (for example) the same 128 ms filter length (and thus the same computational load) can still be used by just delaying the FE signal by estimated delay and putting the 128 ms filter on that region or range. This is valid providing all of the echoes (hybrid(s) tails) are in the given range i.e. 128-256 ms.

The delay detector and the echo canceller and other functions can be implemented in well known programming languages such as C or Ada, or others, as would be well known to those skilled in the art. The resulting code can be cross-compiled into a lower level language appropriate to run on a DSP, such as the fixed or floating point types made by TI or Motorola or others, or on a general purpose microprocessor, or any type of firmware, or programmable or fixed hardware, or any combination. The software can in principle be implemented as instructions or as combinations of data, instructions, rules, objects and so on.

Other variations and implementations within the scope of the claims will be apparent to those skilled in the art, and are not intended to be excluded.

As has been described above, an echo detector correlates between an incoming signal an echo signal to determine echo delay. A preprocesssor extracts a characteristic pattern such as a binary pattern derived by thresholding an averaged power of each signal. This pattern is down sampled then used for the correlation, and delay is deduced from consistent peaks in the correlation. Advantages include reduced computational load, or larger correlation window size, because the characteristic pattern is easier to correlate. The quantising can enhance the correlation peaks, and the averaging can limit the number of transitions, to give more robustness to noise. An echo canceller has a coarse echo delay estimator and a fine echo delay estimator. The coarse estimated delay is used to adjust a delay detection range of a fine delay detector having a narrow range. The output of the fine detector is used to adjust or suppress the adaptive echo canceller.

1. An echo detector having: a correlator for determining a correlation between an incoming signal an echo signal having an echo of the incoming signal, and a preprocesssor for extracting a characteristic pattern from the incoming signal and a characteristic pattern from the echo signal, the correlation being determined by correlating the characteristic patterns, and the detector being arranged to detect the echo from peaks in the correlation.

2. The detector of claim 1, the characteristic patterns being based on a quantised average of the respective signal or its power.

3. The detector of claim 2, the quantisation being binary, using a threshold.

4. The detector of claim 1, having a downsampler fordownsampling the characteristic patterns before the correlation.

5. The detector of claim 1, arranged to determine a delay of the echo from the correlation.

6. The detector of claim 1, the correlator being arranged to carry out the correlation recursively, using results obtained for preceding correlation values for determining a current correlation value.

7. The detector of claim 1, the correlator being arranged to derive a current correlation component by correlating a current sample value of the characteristic pattern of the echo signal and a window of samples of the characteristic pattern of the incoming signal.

8. The detector of claim 1, the characteristic patterns being based on zero crossings of the respective signal.

9. The detector of claim i, the characteristic patterns a being based on auto correlation functions of the respective signal.

10. The detector of claim 1, the characteristic patterns being based on pitch.

11. An adaptive echo canceller having the detector of claim 1, the canceller being adaptable or suppressed according to an output of the detector.

12. The canceller of claim 1 1 and arranged to adapt depending on an output of the echo detector.

13. The canceller of claim 1 1 having an adaptable range of echo delay, the range being adaptable depending on an output of the echo detector.

14. The canceller of claim 11 in the form of software.

15. The detector of claim 1 in the form of software.

16. Central office apparatus having the canceller of claim 11.

17. A method of providing a telecommunications service to subscribers, over a network, and using the central office apparatus of claim 16.

18. An echo detector having a coarse echo delay estimator and a fine echo detector, each arranged to detect echoes having delays within a given range, the range of the coarse detector being wider than the range of the fine detector, the range of the fine detector being adjustable according to an echo delay determined by the coarse echo delay estimator.

19. The detector of claim 18, a centre of the range of the fine detector being adjustable.

20. The detector of claim 18, the coarse echo delay estimator having a correlator for determining a correlation between an incoming signal an echo signal having an echo of the incoming signal, and a preprocesssor for extracting a characteristic pattern from the incoming signal and a characteristic pattern from the echo signal, the correlation being determined by correlating the extracted characteristic patterns, and the detector being arranged to detect the echo from peaks in the correlation.

21. The detector of claim 18, the characteristic pattern being based on a quantised average of the signal or its power.

22. The detector of claim 18, arranged such that a delay value output by the coarse echo delay estimator is compared to a current range of the fine echo detector, and arranged to confirm an echo detection output of the fine echo detector using the result of the comparison.

23. An adaptive echo canceller having a detector as set out in claim 18, and arranged to adapt or suppress a cancellation action on the basis of an output of the coarse echo delay estimator.

24. The canceller of claim 23, having a filter for filtering the incoming signal to model the echo, a centre of a window of the filter being adjustable on the basis of an output of the coarse echo delay estimator.

25. The canceller of claim 24, the centre of the window being adjustable by providing an adjustable delay for delaying the incoming signal before it is input to the filter.

26. The detector of claim 18 in the form of software.

27. A method of producing echo cancelled signals by the steps of: estimating a delay of the echo using a coarse echo delay estimator, arranged to detect a given range of delays, using the estimated delay to adjust a range of a fine delay detector, detecting a delay of the echo using the fine echo delay detector, arranged to detect a narrower range of delays, and using the output of the fine delay detector, to adjust or suppress an adaptive echo canceller, to produce echo cancelled signals.
